(19) United States
(12) Patent Application Publication
(10) Pub. No.: US 2026/0111639 A1
(43) Pub. Date: Apr. 23, 2026

(54) AUTOMATED INPUT GENERATION FOR TRANSISTOR LEVEL POWER ANALYSIS

(71) Applicant: International Business Machines Corporation, Armonk, NY (US)

(72) Inventors: Anurag Umbarkar, Georgetown, TX (US); Nagashyamala R. Dhanwada, Tenafly, NJ (US); Kartik Acharya, Cumming, GA (US); Yisen Wang, Leander, TX (US); Abraham Mathews, Austin, TX (US)

(21) Appl. No.: 18/923,779

(22) Filed: Oct. 23, 2024

(51) Int. Cl. G06F 30/333; G06F 119/06

(52) U.S. Cl. CPC G06F 30/333; G06F 2119/06

(57) ABSTRACT

A computer-implemented method includes receiving a transistor circuit logic architecture and a desired switching profile at a controller. An incomplete machine learning feature is extracted from the transistor circuit logic architecture and from the desired switching profile. The incomplete machine learning feature lacks a set of input vectors. The incomplete machine learning feature is applied to a predictive machine learning model in an inference mode. The set of test input vectors is generated based at least in part on an output of the predictive machine learning model.

### BACKGROUND

The present invention generally relates to power analysis for transistor level circuit designs, and more specifically, to a system for automatically generating input vectors for transistor switching to facilitate power analysis.

Circuit designs for application specific integrated circuits and processor chips typically utilize large numbers of transistors arranged in a logic architecture. As inputs to the logic architecture are changed, values within the architecture are switched from high to low or low to high and subsequent signals change depending on the total inputs. This switching is accomplished via transistor switching. As the signals change, the transistors switch and power is utilized. In a full circuit design process, the logical architectures are tested to ensure that the power levels experienced by the transistors making up the architecture do not exceed rated levels, heat generated by the power expenditure does not exceed desired levels, and similar operational metrics are maintained.

When the metrics determined in the testing do not meet the desired metrics, the transistor circuit is redesigned, and retested.

### SUMMARY

Embodiments of the present invention are directed to a computer-implemented method for automatically generating input sequences based on a logic architecture of the circuit. The input sequences are utilized in performing transistor level power analysis of the logic architecture.

A non-limiting example of the computer-implemented method includes a computer-implemented method includes receiving a transistor circuit logic architecture and a desired switching profile at a controller. An incomplete machine learning feature is extracted from the transistor circuit logic architecture and from the desired switching profile. The incomplete machine learning feature lacks a set of input vectors. The incomplete machine learning feature is applied to a predictive machine learning model in an inference mode. The set of test input vectors is generated based at least in part on an output of the predictive machine learning model.

Embodiments of the present invention are further directed to systems, methods, and computer program products for generating input sequences according to the computer implemented method.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts one exemplary cloud computing system configured to implement the system and method according to an embodiment;

FIG. 2 depicts a block diagram of a system for performing transistor level power analysis;

FIG. 3 depicts a process flow of a method of fabricating an integrated circuit according to exemplary embodiments of the invention;

FIG. 4 depicts a basic logic architecture for a transistor circuit;

FIG. 5 depicts a training data generation process for training a machine learning system; and

FIG. 6 depicts a process for training and utilizing a machine learning system to generate input vectors for a transistor circuit power analysis.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The term “net switching” refers to a percentage of value switching within a single string of binary inputs. By way of example a ten bit binary input vector of 1-1-1-0-0-1-0-0-0-1 switches values four times, and would have a net switching value of 40%.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Computing environment 100 contains an example of an environment for the execution of at least some of the computer code involved in performing the inventive methods, such as providing a transistor level power analysis at block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 142, virtual machine set 143, and container set 144.

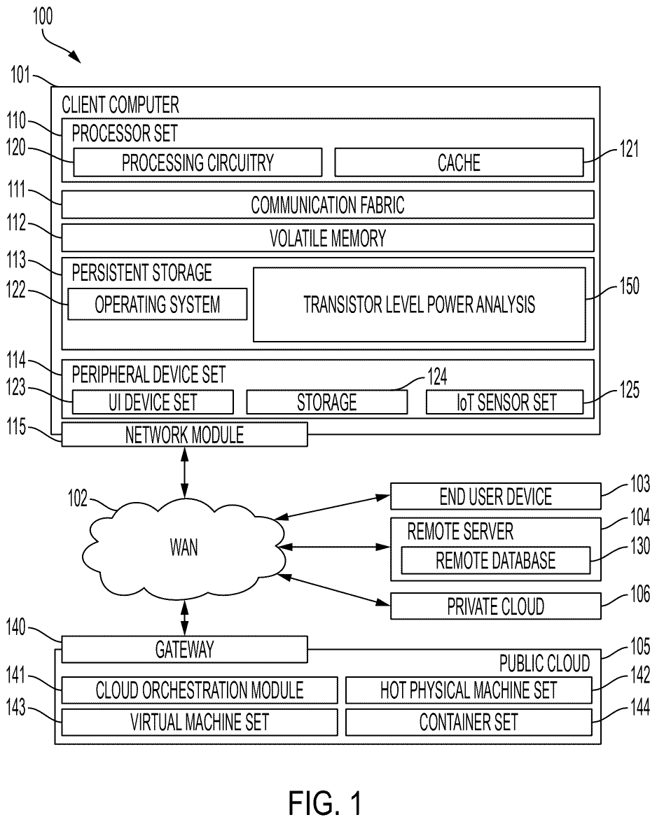

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Turning now to an overview of technologies that are more specifically relevant to aspects of the invention, transistor circuits, such as those utilized in constructing logical architecture for a computer processor or similar component, include large numbers of transistors arranged in an architecture that performs logical functions based on inputs. The logical functions are sequences of AND gates, OR gates, NAND gates, XOR gates, and the like. In a typical example, the logical functions are arranged in logic subcircuits that perform specific logical operations and the full logical architecture is constructed of multiple logic subcircuits.

Each logic circuit and/or subcircuit (referred to generally as logic circuit(s)) includes a set number of binary inputs, which can either be a 1 (high) or 0 (low) value. A time sequence of binary inputs provided to a single input is referred to as an input vector. As the input vectors provided to the logic architecture change states, transistor switch states and power levels at any given transistor within the logic circuit may change. Due to the constant switching that occurs during expected operations, power is utilized and a power analysis of the transistor circuit is performed using power analysis tools during the design process. The power analysis tools use an underlying circuit simulator and run multiple simulations for various operational modes of the logic circuit by providing input vectors to each input of the logic circuit and monitoring operation of the transistor circuit from which the logic circuit is constructed. The simulations provide output metrics including alternating current analysis, leakage analysis, pincap analysis, electromagnetic analysis, self heating analysis, and the like.

Based on the output metrics a design team determines if the transistor circuit from which the logic architecture is constructed should be altered. When the design team determined that the circuit should be altered, the design team redesigns the circuit and the analysis is performed again.

In current implementations of this analysis, highly trained and/or experienced individual designers manually configure input pattern definitions (the input vectors) for each mode of expected operations of the logic architecture based on the designer's personal experience and knowledge of the structure of the circuits and subcircuits from which the logical architecture is constructed. This process for developing the input vectors requires substantial amounts of time and effort from specific individual designers. In some cases, due to the lack of an easy-to-use framework for exploring different switching profiles in a transistor circuit, the process of designing input vectors can require a month or more in order to fully design the input vectors for a single test of a transistor circuit.

The process described herein leverages machine learning to identify correlations between transistor circuits, inputs, and simulated metrics using training data sets developed according to the methods described herein. Once trained, the machine learning system is able to generate input vectors for the logic architecture of a specific transistor circuit and provide the input vectors to circuit designers who can then run simulations and perform the transistor level power analysis in a matter of hours or days without waiting for the highly trained or experienced designer to develop input vectors for the simulation.

Turning now to an overview of the aspects of the invention, one or more embodiments of the invention address the above-described shortcomings of the prior art by providing a simple mechanism to assert desired coverage and targeted switching for running power simulations without requiring the time or experience to develop the correct sequences of 1's and 0's for each input vector. The input vectors provided by the machine learning system are custom created for different transistor circuit array families, based on higher level user assertions (e.g., the logic circuit and subcircuits, the expected operations of the transistor circuit, and the function of the logic circuit). This improves ease of pattern generation and reduces the time required to implement power analysis, thereby improving their efficiency of the design process significantly. The process also helps improve the design power profile of transistor circuits by providing a consistent framework to explore different net switching activities within a transistor circuit without the impact of biases that may be present with a single experienced designer and while minimizing the impact of human error.

The above-described aspects of the invention address shortcomings present in the prior art by automatically generating input vectors for power simulations using a machine learning process trained with the structural differences and switching behaviors of distinct logic architecture.

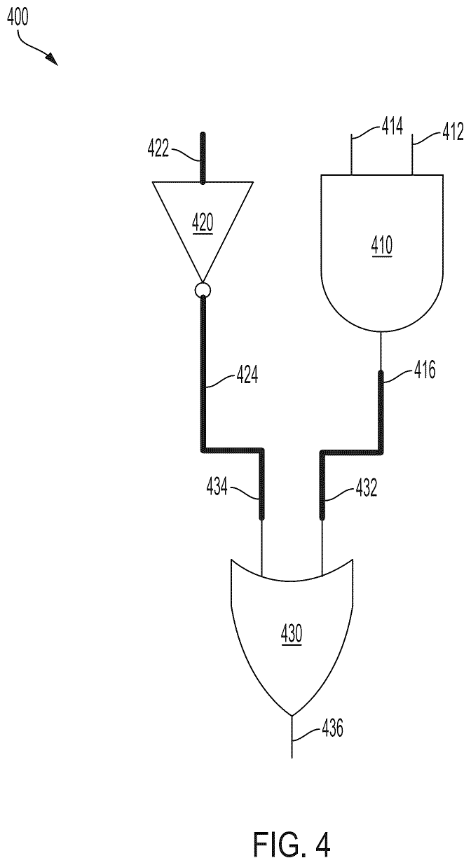

Turning now to a more detailed description of aspects of the present invention, FIG. 4 depicts an example logic architecture 400. The example logic architecture 400 includes an AND gate 410, and NOT gate 420, and an OR gate 430. The AND gate 410 includes two inputs 412, 414 and the NOT gate includes one input 422. Each of the AND gate 410 and the NOT gate 420 include corresponding outputs 416, 424. The outputs 416, 424 are provided to the OR gate 430 as inputs 432, 434 and the OR gate 430 generates a corresponding output 436. In a practical application, the logic architecture will include a substantially larger number of interconnected logic gates formed from multiple logical sub-architecture. The simpler logic architecture of FIG. 4 is provided for ease of explanation.

The values of the inputs 412, 414, 422 and particular outputs 416, 424 of each gate 410, 420, 430 depend on the input vectors and switching a value provided to one input 412,414, 422 can alter the outputs of subsequent gates in a cascading manner. This cascading switching results in power consumption at the transistor level as one or more other inputs in the logical architecture 400 change states. When running a simulation to check the power levels in the transistor level power analysis, each top level input 412, 414, 422 is provided a sequence of bits (1's or 0's), with each sequence being referred to as the input vector for that input 412, 414, 422. As used herein a top level input is an initial input (inputs 412, 414, 422) to the logic architecture 400 and does not refer to subsequent inputs (inputs 432, 434) which depend on logic gates within the logic architecture 400.

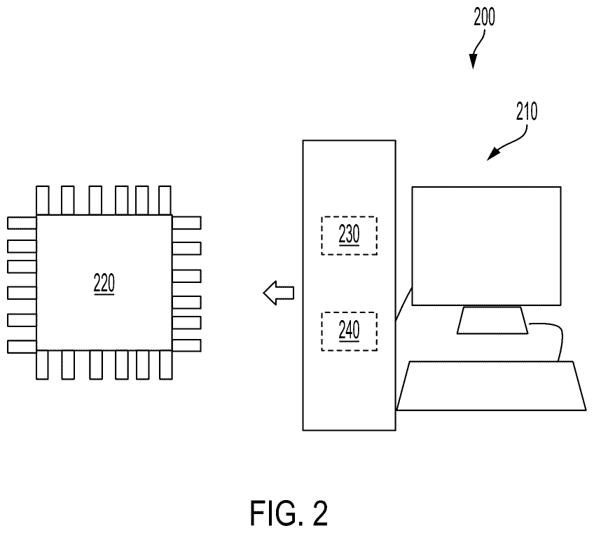

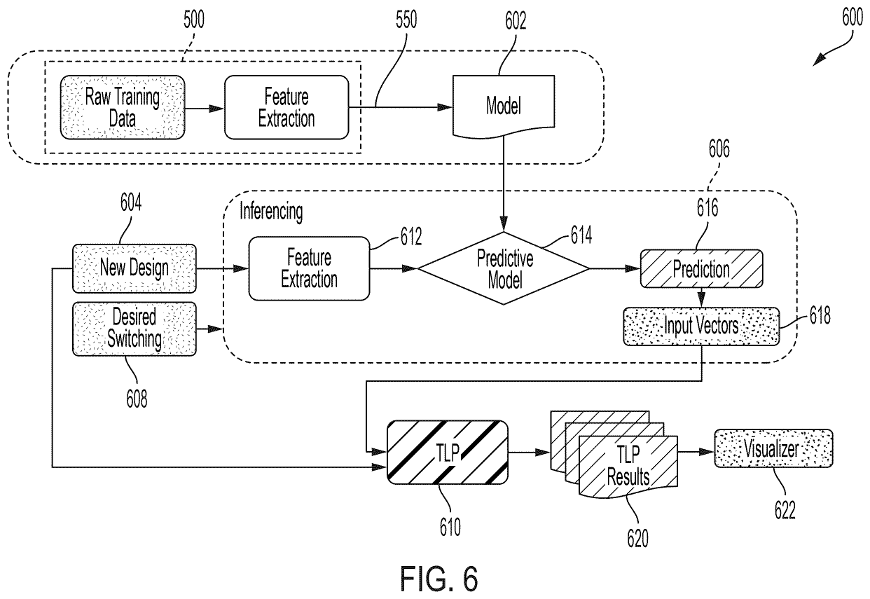

With continued reference to FIGS. 1-4, FIG. 5 depicts a training data generation process 500 for generating training data to train a machine learning based input generation process, such as the process 600 illustrated in FIG. 6. The training data generation process 500 initially runs simulations 502 on established logic architectures and the output of the simulation is provided to a waveform analyzer 504. A design specification 506 is provided to the waveform analyzer and describes the structure and function of the logic architecture being analyzed. In addition, any user options 508 that are applied to the simulation 502 are provided to the waveform analyzer 504.

The waveform analyzer uses the design specification 506 and any identified user options 508 to generate an output net switching activity. The output net switching activity is referred to as the activity profile 510 of the simulation. The activity profile 510 includes switch factor data (switch factor, % of nets switching, % not switching) and an average amount of switching for the logic architecture during the simulation.

In addition to the activity profile 510, a subcircuit pattern matcher 520 reviews the logic architecture for groups of logic gates connected in known manners to perform established functions. The subcircuit pattern matcher 520 outputs the patterns of logic subcircuits within the logic architecture 400 being analyzed as a set of matched circuit patterns 522. In addition, the process 500 identifies the simulation results 530.

The identified logic simulation results 530, matched circuit patterns 522, and net switching activity 510 of a single simulation are combined into a single data point, referred to as a machine learning feature 550. This process is performed with multiple logic architecture simulations until sufficient machine learning features 550 are provided to constitute a full machine learning training data set. In one example, a minimum of 100 machine learning features 550 are required to fully train a machine learning system.

In one example, each machine learning feature defines an input vector, a mode of operation (e.g. Idle, EM, etc.), a switch factor, a number of bits in the input vector (referred to as a size of the input vector), clock information of the input vector, a design profile of the logic architecture include functional labels (e.g., a label defining the function of the logic architecture in plain language), a quantity of each type of logic block within the logic architecture, a binary classification of the architecture as high switching or not high switching, physical information defining the logic architecture including a number of nets, a number of input/output pins, a number of gates, and an area of the logic architecture, the activity profile (a waveform analyzer), switch factor data (including the switch factor, the percentage of nets switching, and the percentage of nets not switching, and the average switching for each data type. In alternate examples, the machine learning feature 550 can include additional components and/or omit some of the listed components depending on the particular implementation.

Once a sufficient machine learning feature 550 set is developed to train a machine learning algorithm, the algorithm is trained to make connections and correlations between the provided components of each machine learning feature. The machine learning algorithm utilizes a loss function during the process of training the model. In one example, the loss function is a MSE (Mean Square Error) loss function. In alternate examples, other loss functions such as self-defined MSE, Hamming Loss, Cross-Entropy Loss, Focal Loss, Jaccard Loss, or our own custom loss function could be utilized instead. In the alternate examples, the particular loss function utilized depends on whether a single switch factor, multiple switch factors, or entire bit vectors are predicted.

In one example, the machine learning system is trained using a deep learning model with multi-linear perceptron. In alternate examples, the machine learning model can be a long-short term memory model, a convolutional neural network model, a reinforcement learning model, or any similar machine learning model.

After training, the trained machine learning model can be placed in an inference mode. While in the inference mode, the machine learning model can receive an incomplete machine learning feature (e.g. all components except for the input vectors) and generate an output that completes the machine learning feature.

The machine learning model may, in some examples, be trained to output a switching rate for each input or groups of inputs and an automated tool can randomly generate 1's and 0's meeting the switching rate, thereby allowing the tools to provide a full set of input vectors.

In alternative examples, the trained machine learning model is configured to generate specific input vectors including a fully defined input vector of 1's and 0's and/or an input vector for the corresponding mode of operation.

With continued reference to FIGS. 1-5, FIG. 6 illustrates and exemplary process flow 600 for developing a machine learning model 602 to generate input vectors for a transistor level power tool 610 based on a received logic architecture of a transistor circuit (new design 604) using an inferencing process 606.

The inferencing process 606 receives the new design 604 and a desired switching type 608. The desired switching type 608 is the practical use case of the transistor circuit being tested. In some examples, the switching type 608 is a memory switching type and corresponds to a transistor circuit designed to be utilized in a memory capacity. In other examples, the desired switching type 608 may correspond to any other expected use. In yet further examples, multiple uses and/or a “general power test” type may be used indicating that the transistor circuit should be tested with an unknown or all purpose use case.

A feature extraction 612 system in the inferencing process 606 extracts a machine learning feature from the new design 604 and the desired switching type 608. The extracted machine learning feature includes all the components of the machine learning features 550, with the exception of the input vector(s).

The machine learning model 602 is placed in the inferencing mode and provided as a predictive model 614 and receives the feature from the feature extraction 612. The predictive model provides a prediction 616 (output) based on the incomplete received machine learning feature which allows the incomplete machine learning feature to be completed. In examples where the predictive model 614 provides a switching rate of the input vector(s) an input vector generation tool 618 generates a random string of 1's and 0's that meets the provided switching rate, and the string is used as the input vector. In alternative examples, where specific input vector(s) are output as the prediction 616, the input vector generation tool 618 can be omitted.

Each of the input vector(s) and the new design 604 are provided to the transistor level power analysis tool 610 which runs a simulation of the new design 604 and outputs results 620 corresponding transistor level power metrics that occurred during the simulation. The results 620 are converted into a visual form using a visualizer 622 and displayed to the designers.

A circuit designer can review the display provided by the visualizer 622 and determine if the logic architecture 400 is within desirable parameters for all the monitored metrics. If the logic architecture 400 is not within the metrics the designer can then revise the architecture and rerun the process 600. By using the predictive model 614 based on the trained machine learning model 602 the delay and inefficiencies associated with relying on a single highly experienced designer to develop input vectors can be bypassed allowing for the design process to be completed substantially quicker.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

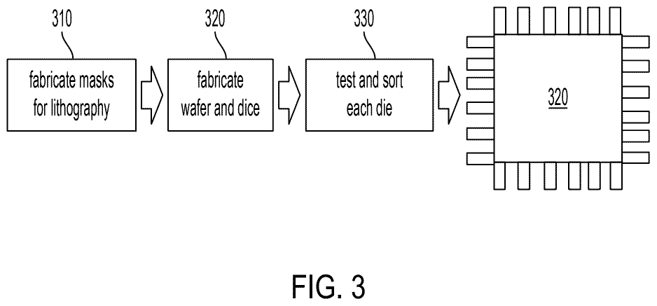

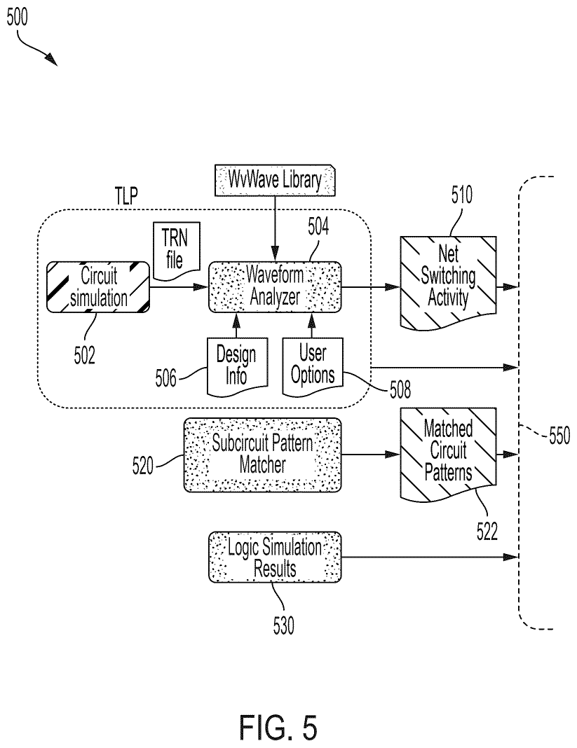

With continued reference to FIGS. 1 and 4-6, FIG. 2 is a block diagram of a system 200 for performing the transistor level power analysis described at FIGS. 5 and 6 according to embodiments of the invention. The system 200 includes processing circuitry 210 used to generate the design that is ultimately fabricated into an integrated circuit 220. The steps involved in the fabrication of the integrated circuit 220 are well-known and briefly described herein. Once the physical layout is finalized, based, in part, on a transistor level power analysis 230 performed using inputs generated from a machine learning system 240 according to embodiments of the invention to facilitate optimization of the routing plan, the finalized physical layout is provided to a foundry. Masks are generated for each layer of the integrated circuit based on the finalized physical layout. Then, the wafer is processed in the sequence of the mask order. The processing includes photolithography and etch. This is further discussed with reference to FIG. 3.

With continued reference to FIGS. 1, 2, and 4-6, FIG. 3 is a process flow of a method of fabricating the integrated circuit according to exemplary embodiments of the invention. Once the physical design data is obtained, based, in part, on the transistor level power analysis, the integrated circuit 220 can be fabricated according to known processes that are generally described with reference to FIG. 3. Generally, a wafer with multiple copies of the final design is fabricated and cut (i.e., diced) such that each die is one copy of the integrated circuit 220. At block 310, the processes include fabricating masks for lithography based on the finalized physical layout. At block 320, fabricating the wafer includes using the masks to perform photolithography and etching. Once the wafer is diced, testing and sorting each die is performed, at block 330, to filter out any faulty die.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving a transistor circuit logic architecture and a desired switching profile at a controller;
extracting an incomplete machine learning feature from the transistor circuit logic architecture and the desired switching profile, wherein the incomplete machine learning feature lacks a set of input vectors;
applying the incomplete machine learning feature to a predictive machine learning model in an inference mode; and
generating the set of test input vectors based at least in part on an output of the predictive machine learning model.

2. The computer-implemented method of claim 1, wherein the output of the predictive learning machine model is a net switching rate for each input or group of inputs of the transistor circuit logic architecture.

3. The computer-implemented method of claim 2, wherein generating the set of input vectors based at least in part on the output of the predictive machine learning model includes converting each net switching rate to a binary input vector by randomly generating sequential ones and zeroes meeting the switching rate.

4. The computer-implemented method of claim 1, wherein the output of the predictive learning machine model includes an input vector for each input of the transistor circuit logic architecture.

5. The computer-implemented method of claim 1, further comprising training the predictive machine learning model using a training data set, wherein the training data set is comprised of a set of machine learning features generated by:
for each machine learning feature in the set of machine learning features, receiving a logic architecture and a set of input vectors corresponding to the logic architecture, performing a transistor level power analysis of the logic architecture, performing a logic simulation of the logic architecture, and identifying at least one subcircuit within the logic architecture using a subcircuit pattern matcher.

6. The computer-implemented method of claim 5, wherein the subcircuit pattern matcher further identifies a total number of each type of logic block within the logic architecture.

7. The computer-implemented method of claim 6, wherein the subcircuit pattern matcher further determines a total number of input pins, a total number of output pins, and a total number of gates within the transistor circuit logic architecture.

8. The computer-implemented method of claim 5, wherein each machine learning feature in the set of machine learning features defines at least one input vector, a mode of operation of the transistor circuit logic architecture, a switch factor of the at least one input vector, a number of bits in the input vector, clock information of the input vector, a design profile of the transistor circuit logic architecture include, functional labels of the transistor circuit logic architecture, a quantity of each type of logic block within the logic architecture, a binary classification of the architecture as high switching or not high switching, physical information defining the logic architecture including a number of nets, a number of input/output pins, a number of gates, and an area of the logic architecture, an activity profile of the transistor circuit logic architecture, and switch factor.

9. The computer-implemented method of claim 1, further comprising performing a transistor level power analysis of the transistor circuit logic architecture using the set of test input vectors, generating a visualization of the transistor level power analysis, and displaying the visualization to a user.

10. The computer-implemented method of claim 9, further comprising responding to an output of the transistor level power analysis meeting a set of metrics by manufacturing a transistor circuit including the transistor circuit logic architecture.

11. A non-transitory computer-readable medium storing instructions for causing a computer system to perform a process including:
receiving a transistor circuit logic architecture and a desired switching profile at a controller;
extracting an incomplete machine learning feature from the transistor circuit logic architecture and the desired switching profile, wherein the incomplete machine learning feature lacks a set of input vectors;
applying the incomplete machine learning feature to a predictive machine learning model in an inference mode; and
generating the set of test input vectors based at least in part on an output of the predictive machine learning model.

12. The non-transitory computer-readable medium of claim 11, wherein the output of the predictive learning machine model is a net switching rate for each input of the transistor circuit logic architecture.

13. The non-transitory computer-readable medium of claim 12, wherein generating the set of input vectors based at least in part on the output of the predictive machine learning model includes converting each net switching rate to a binary input vector by randomly generating sequential ones and zeroes meeting the switching rate.

14. The non-transitory computer-readable medium of claim 11, wherein the output of the predictive learning machine model includes an input vector for each input of the transistor circuit logic architecture.

15. The non-transitory computer-readable medium claim 11, further comprising training the predictive machine learning model using a training data set, wherein the training data set is comprised of a set of machine learning features generated by:
for each machine learning feature in the set of machine learning features, receiving a logic architecture and a set of input vectors corresponding to the logic architecture, performing a transistor level power analysis of the logic architecture, performing a logic simulation of the logic architecture, and identifying at least one subcircuit within the logic architecture using a subcircuit pattern matcher.

16. The non-transitory computer-readable medium of claim 15, wherein the subcircuit pattern matcher further identifies a total number of each type of logic block within the logic architecture.

17. The non-transitory computer-readable medium of claim 16, wherein the subcircuit pattern matcher further determines a total number of input pins, a total number of output pins, and a total number of gates within the transistor circuit logic architecture.

18. The non-transitory computer-readable medium of claim 15, wherein each machine learning feature in the set of machine learning features defines at least one input vector, a mode of operation of the transistor circuit logic architecture, a switch factor of the at least one input vector, a number of bits in the input vector, clock information of the input vector, a design profile of the transistor circuit logic architecture include, functional labels of the transistor circuit logic architecture, a quantity of each type of logic block within the logic architecture, a binary classification of the architecture as high switching or not high switching, physical information defining the logic architecture including a number of nets, a number of input/output pins, a number of gates, and an area of the logic architecture, an activity profile of the transistor circuit logic architecture, and switch factor.

19. The non-transitory computer-readable medium of claim 11, further comprising performing a transistor level power analysis of the transistor circuit logic architecture using the set of test input vectors, generating a visualization of the transistor level power analysis, and displaying the visualization to a user.

20. A computer system comprising:
a processor set and a non-transitory memory, the non-transitory memory storing instructions for causing the processor set to
extract an incomplete machine learning feature from a transistor circuit logic architecture and a desired switching profile, wherein the incomplete machine learning feature lacks a set of input vectors;
applying the incomplete machine learning feature to a predictive machine learning model in an inference mode; and
generate the set of test input vectors based at least in part on an output of the predictive machine learning mode.
